(19) United States
(12) Patent Application Publication
(10) Pub. No.: US 2005/0262801 A1
(43) Pub. Date: Dec. 1, 2005

(54) Core material for lightweight building constructions in a multi-layer mode of construction

(75) Inventors: Oswald Landwehr, Meckenheim (DE); Ilse Adeline Lisa Landwehr, Meckenheim (DE); Erich Wintermantel, Bonn (DE)

Correspondence Address: STITES & HARBISON PLLC, 1199 NORTH FAIRFAX STREET, SUITE 900, ALEXANDRIA, VA, 22314, US

(73) Assignee: Erich Wintermantel

(21) Appl. No.: 11/136,667

(22) Filed: May 25, 2005

(30) Foreign Application Priority Data
May 26, 2004 (DE) 10 2004 025 667.5

(51) Int. Cl. G21C 3/32

(52) U.S. Cl. 52/793.1

(57) ABSTRACT

This invention relates to core materials for lightweight building constructions in a multi-layer mode of construction, which are also termed sandwich constructions. The core material according to the invention can be used in combination with all metallic or non-metallic (cladding) layers which are suitable for sandwich constructions. The core material according to the invention consists of a basic structure, preferably of a composite material comprising bedding or sealing material as well as a reinforcement, and optionally filling materials in addition depending on the embodiment. The geometric structure of the core material according to the invention is lattice-like. Each lattice cell consists of lattice cell walls which can be closed or perforated like a mesh, and of a cell volume which can be empty or which can be completely or partly filled. The core material according to the invention is characterised in that between adjacent lattice cells the lattice cell walls, particularly in the form of part of their reinforcement, interpenetrate each other without interruption whilst retaining their respective directional course, and thus at the same time form portions of the walls of adjacent lattice cells.

### FIELD OF THE INVENTION

This invention relates to core materials for lightweight building constructions in a multi-layer mode of construction.

### BACKGROUND

Lightweight building constructions in the form of flat or curved shells are of multi-layer construction in order to achieve a sufficiently high stiffness in particular. Multi-layer constructions, which are also termed sandwich constructions, consist of (cladding) layers disposed at a spacing from each other and a core inserted therebetween, which holds the (cladding) layers at a spacing and joins them. Under load, the (cladding) layer and core structure act as a unit, i.e. as a static system.

Core materials for lightweight sandwich building constructions are known in the form of flat and curved shells. In general, the density over the entire core cross-section is lower than the density of the cladding layers over the cross-section. Known core materials or core constructions are as follows:
a) materials with a comparatively low specific gravity; apart from timber products, particularly balsa wood, these include various plastics,
b) materials with a comparatively low specific gravity and a large proportion of gas-filled pores or cells; these include most plastics foams,
c) materials with a comparatively high specific gravity and a large proportion of gas-filled pores or cells; amongst other materials, these include foamed and fibre-containing mineral and metallic materials such as foamed glass, foamed aluminium, as well as glass wool, rock wool and steel wool,
d) honeycomb constructions with a comparatively low proportion by volume of honeycomb walls in relation to the volume of the construction as a whole, wherein the material of the honeycomb walls can have either a comparatively low or a comparatively high specific gravity; these include honeycomb cores with honeycomb walls made of substantially natural starting materials such as cellulose, or made of thermoplastic and thermosetting plastics with and without (fibre) reinforcement, as well as honeycomb cores with honeycomb walls made of metal, particularly a light metal such as aluminium or titanium,
e) honeycomb constructions as in d), in which, depending on the cross-sectional geometry of the honeycomb cells, the honeycomb walls of adjacent honeycomb cells are joined at points, along lines or over areas, e.g. by a mechanical joint or by adhesive bonding or fusion,
f) honeycomb constructions as in d) and e) in which the honeycomb cells are filled, by insertion, foaming or casting, with natural or synthetic materials.

It is known that core materials and substances and honeycomb constructions can be formed, during the fabrication process therefore or by subsequent processing, so that they have different cross-sections in different sectional planes and so that they have boundary faces which are curved towards the cladding layers.

### SUMMARY OF INVENTION

The core material according to preferred embodiments of the invention can be used in combination with all metallic or non-metallic (cladding) layers which are suitable for sandwich constructions. The core material according to the invention is preferably mechanically bonded to the adjacent layers by means of joining materials such as adhesives for example, which are matched firstly to the material and nature of the core material and secondly to the method of producing the sandwich construction and the requirements imposed on the constructions in use. Alternatively, skins (ie. cladding layers) maybe applied to the core material by spraying or casting methods.

The basic structure of the core material according to the invention preferably consists of a composite material comprising bedding or sealing material, as well as a reinforcement, and optionally filling materials in addition in some embodiments. The bedding or sealing material of the basic structure may be a natural or synthetic material. The reinforcement is fibrous or ribbon- or strip-shaped, for example, and can consist of or comprise a natural, metallic or non-metallic material or a synthetic material. The reinforcing fibres, ribbons or strips are oriented, for example, in the form of a woven fabric, a lay-up or a knitted fabric.

The preferred geometric structure of the core material according to the invention is lattice-like. Each lattice cell consists of lattice cell walls which can be closed or perforated like a mesh, and of a cell volume which can be empty or which can be completely or partly filled with a natural or synthetic (filler) material.

The core may comprise a foamed synthetic material as a filler for example. Suitable materials for foaming include polypropylene, styrene acrylonitrile (SAN), polyvinyl chloride (PVC) and acrylic foams.

In accordance with one aspect of the core material of the invention, the lattice cell walls between adjacent lattice cells, particularly in the form of part of their reinforcement, interpenetrate or intersect each other without interruption whilst retaining their respective directional course, and thus at the same time form portions of the walls of adjacent lattice cells.

In sandwich constructions, particularly where the core material comprises a synthetic foam, it can be difficult to ensure a good bond between the core and the skin materials (ie. cladding layer or layers), which may for example by polyesters or epoxys. The synthetic foams may also not bond well to adhesive materials. It is important, however, to be able to provide a foamed core for some applications and processing methods, for example resin transfer moulding (RTM) and vacuum assisted resin injection (VARI) where it is necessary to have filled cavities in the core material to prevent ingress of the resin.

In preferred embodiments of the invention, especially where the core material comprises a foamed material (eg. filler), the reinforcement comprises elements that have brush-like end portions (at one or both ends). That is, one or both end portions are divided, for example, by cutting the end or ends of a fibrous reinforcement element. By using such reinforcement elements in a core material, with the brush-like end portions at the surface of the core, the cladding layers can be more securely bonded to the core as bonding can occur between the cladding layers and the splayed, brush-like end portions of the reinforcements. The splayed ends means the bond is formed across a wider area rather than point or linear bonds that might be formed with the ends of more conventional reinforcements.

Conveniently, the core material may be formed as an elongate member with its longitudinal axis perpendicular to the plane of the lattice cells (i.e. the lattice cell structure is seen in the cross-section of the elongate member). The core member can then be cut along cross-sectional planes (or at an angle to a cross-sectional plane to provide varying geometries) into a plurality of slices of the desired thickness. The cut faces of the slices provide the upper and lower surfaces to which cladding layers can be bonded to form a sandwich construction.

Where the lattice cells are filled, for example with a foamed material as discussed above, prior to slicing of the elongate core material member (which is desired), it may be that the reinforcement in the material is submerged in the filling material at the upper and lower surfaces of each slice. Particularly where the reinforcement has brush-like ends (as discussed above), this may prevent adequate bonding with later applied cladding layers. Desirably, therefore, after the core material is sliced, the filling material (e.g. foamed material) is treated (e.g. mechanically or chemically treated) to reveal the ends of the reinforcements. For example, a chemical or mechanical treatment may be used to cause the filling to shrink a little. Appropriate treatments will be well known in the art.

The core material according to a preferred aspect of the invention may consist of simple core bars comprising a plurality of lattice cells which are disposed one behind another in one direction, or of multiple core bars comprising a plurality of lattice cells which are disposed both one behind another and side by side and/or one above another. The mid-points of a plurality of lattice cells disposed one behind another or side by side in one direction and/or one above another can be aligned linearly or offset in relation to each other. At the upper and lower boundary faces of the core material, i.e. at the boundary faces which are aligned towards the cladding layers, the lattice cells can have the same or different cross-sections. The cross-sectional geometry of the lattice cells can be uniform or non-uniform, e.g. circular, oval or polygonal. The walls of the lattice cells can be perpendicular to the upper and lower boundary faces or can form an angle which differs from 90° to meet the boundary faces obliquely.

Core bars according to the invention can be combined and joined in a variety of ways to form core materials with different constructions, such as one or more of the following, for example:
single and multiple core bars comprising lattice cells which are aligned identically or differently in relation to each other,
core bars comprising lattice cells of the same or different cross-sectional geometry,
core bars comprising lattice cells, the cell volumes of which are empty or which are completely or partly, identically or differently filled,
core bars comprising lattice cells, the cell walls of which consist of identical or different materials, and
core bars comprising lattice cells, the cell walls of which have identical or different angular positions in relation to the boundary faces which are aligned towards the cladding layers.

### BRIEF DESCRIPTION OF THE DRAWINGS

Embodiments of the invention are described below, by way of example, with reference to the accompanying drawings, in which:

FIG. 1 is a perspective illustration of a core material according to an embodiment of the invention, shown sandwiched between cladding layers;

FIG. 2 is a perspective illustration of a core material according to another embodiment of the invention having a multiply-curved form;

FIG. 3 is a perspective illustration of a core material according to another embodiment of the invention, having the form of a wedge, in which the cell volumes are completely filled with a filling material;

FIGS. 4 to 7 are each plan views of further different embodiments of core bars according to the invention which consist of a plurality of lattice cells according to embodiments of the invention which are joined to each other;

FIG. 8a is a side view and FIG. 8b is a perspective illustration of a lattice cell showing more detail of a core material according to an embodiment of the invention, in which regions of the lattice cell walls are aligned in relation to the upper and lower boundary faces at an angle which differs from 90°;

FIG. 9a is a plan view and FIGS. 9b, 9c and 9d are three cross-sections of a core material according to an embodiment of the invention which comprises a plurality of differently constructed core bars.

FIG. 10 is a cross-section through a core material according to another embodiment of the invention, in which reinforcing fibres in the core have brush-like cut ends;

FIG. 11 shows two examples of the core material of FIG. 10 with a sandwich skin bonded to one and both sides respectively; and

FIG. 12 shows the core material of FIG. 10 with filled (eg. foamed out) lattice cells and sandwich skins bonded to both sides.

### DESCRIPTION OF EMBODIMENTS

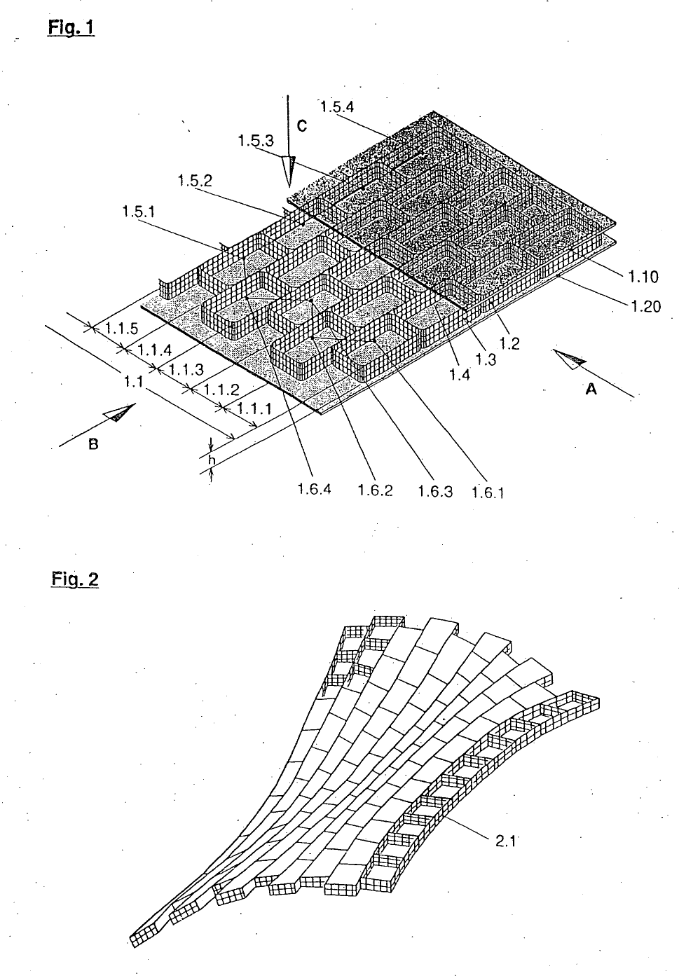

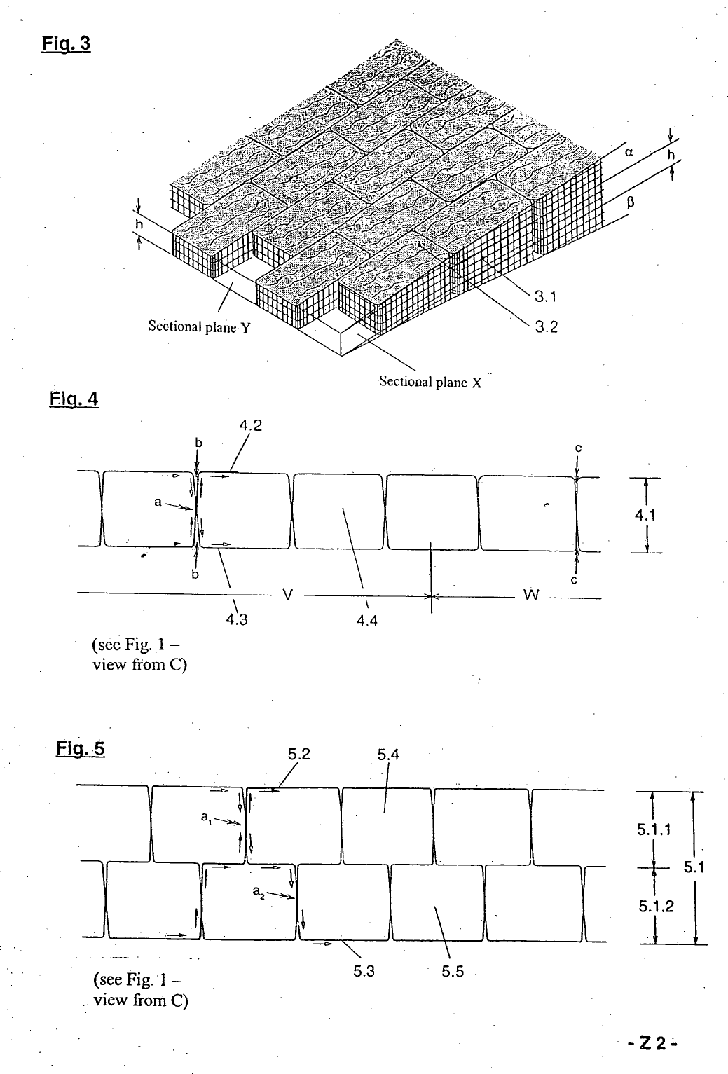

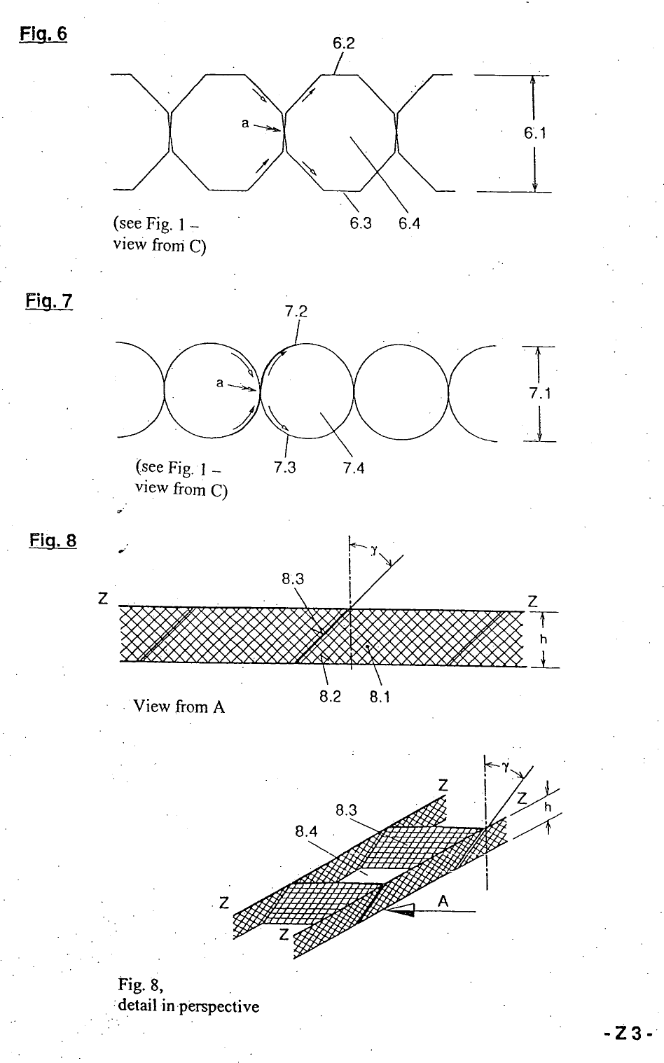

FIG. 1 to FIG. 12 of the drawings illustrate examples of core materials according to embodiments of the invention. The examples shown in FIGS. 1 to 12 will now be described in detail.

FIG. 1 shows a lattice-like core material 1.1 according to the invention consisting of a plurality of core bars 1.1.1, 1.1.2, 1.1.3, 1.1.4 and 1.1.5 according to the invention. Part of core material 1.1 adjoins a cladding layer 1.10 at the top, and the entire face of said core material adjoins a cladding layer 1.20 at the bottom. The spacing of the cladding layers from each other is determined by the height h of the core material, which for all core materials according to embodiments of the invention may be dimensioned as required. The walls 1.2 of the lattice cells 1.4 consist of a composite material comprising reinforcing fibres, ribbons or strips 1.3. The walls can be closed or can comprise permeable mesh apertures. Within each core bar 1.1.1 to 1.1.5 the (imaginary) mid-points of the lattice cells 1.5.1, 1.5.2, 1.5.3 and 1.5.4 are aligned linearly. The core bars 1.1.1 to 1.1.5 are positioned side by side so that the (imaginary) mid-points 1.6.1, 1.6.2, 1.6.3 and 1.6.4 of adjacent lattice cells 1.4 are each offset in relation to each other.

Conveniently, the core material can be formed as an elongate member with its longitudinal axis extending in the direction of arrow C in FIG. 1. Such an elongate member can the be cut into multiple slices of the desired height h.

FIG. 2 shows a core material 2.1 in multiply-curved form, that is in which the core bars are each curved, with some or all of the bars being curved to a greater or lesser extent than others. The curvature may be in the plane of the bar or out of this plane. This approach can be used to create a core material having contoured surfaces of any desired form, for example as seen in the figure. Otherwise, the details of this core material are as described for core material 1.1 in FIG. 1.

FIG. 3 shows a wedge-shape core material 3.1 in which the lattice cells are completely filled with a filling material 3.2, e.g. an insulating material made of a natural or synthetic substance. The filling material may, for example, be a natural wool or a foamed synthetic material such as a foamed polypropylene, styrene acrylonitrile (SAN), polyvinyl chloride (PVC) or an acrylic foam. In sectional plane Y, this core material has a constant core height h; in sectional plane X the core height h increases in the form of a wedge by an angle α at the top and by an angle β at the bottom. Otherwise, the details of core material 3.1 are as described for core material 1.1 in FIG. 1.

FIG. 4 is a plan view of a single core bar 4.1 that can be used, for example, in the core material of FIG. 1 (as viewed in direction of arrow C in FIG. 1). The courses of the lattice cell walls and of the reinforcing fibres, ribbons or strips 4.2 and 4.3, respectively, clearly illustrate the characterising feature of the core materials according to the invention. The walls or reinforcing fibres, ribbons or strips intersect or interpenetrate each other without interruption, whilst retaining their directional courses so that at the same time they are constituent portions of walls in adjacent cells, ie. the adjacent walls (defined for example with reference to the wall reinforcements) cross through one another (in this example at a mid-point of their length) so that both walls define respective portions of both cell boundaries.

The intersecting walls can be opened out in the shape of an X to a greater or lesser extent, or can extend in closed form on a line—compare b in lattice cell region V with c in region W for example.

FIG. 5 is a plan view of a twin core bar that can be used, for example, in the core material of FIG. 1, (as viewed in direction of arrow C in FIG. 1). The twin core bar 5.1 consists of two integrally joined core bar parts 5.1.1 and 5.2.2. The lattice cells 5.4 of bar part 5.1.1 are positioned so that they are offset in relation to the lattice cells 5.5 of bar part 5.1.2. The courses of the lattice cell walls and of the reinforcing fibres, ribbons or strips 5.2 and 5.3, respectively, extend in a manner in accordance with the invention so that they interpenetrate or intersect each other without interruption whilst retaining their direction (see planes of intersection a₁ and a₂), and thus at the same time form portions of the walls of adjacent lattice cells. They are thus constituents of a portion of a wall both in the linearly adjacent lattice cells of the same bar part and of the adjacent offset part of the twin bar.

FIG. 6 shows a core material according to an embodiment of the invention in the form of a single core bar 6.1. The type of illustration used for this drawing and the structure of the core bar correspond to those of FIG. 4. However, the cross-section of the lattice cells 6.4 is octagonal here. The walls and wall reinforcements 6.2 and 6.3, respectively, interpenetrate (intersect) each other at a in the manner described above in accordance with the invention.

FIG. 7 shows a core material according to an embodiment of the invention in the form of a single core bar 7.1. The type of illustration used for this drawing and the structure of the core bar correspond to those of FIG. 4 and FIG. 6. However, the cross-section of the lattice cells 7.4 is circular here. The walls and wall reinforcements 7.2 and 7.3, respectively, interpenetrate (intersect) each other at a in the manner described above in accordance with the invention.

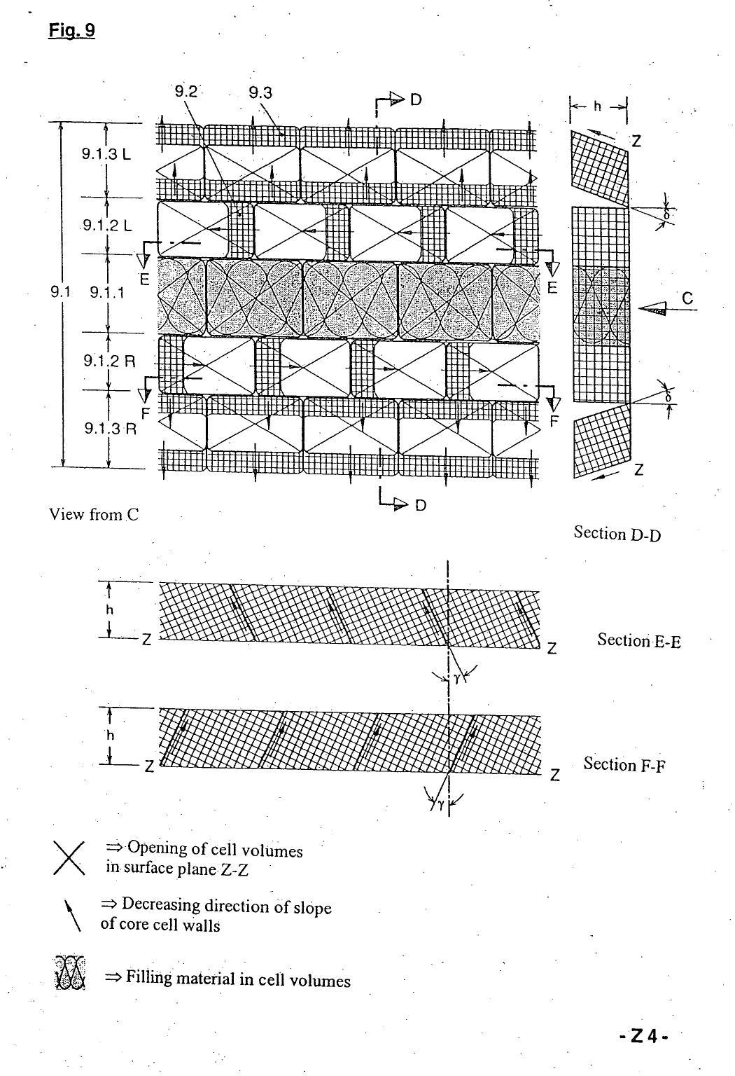

FIG. 8a is a side view (as, for example, would be seen in direction of arrow A in FIG. 1) of a core material 8.1 with a core height h. FIG. 8b is a perspective illustration of a lattice cell 8.4 of the core material 8.1. The reinforcing fibres, ribbons or strips 8.2 which form the lattice cell walls, as well as the lattice cell walls 8.3 between adjacent lattice cells, which interpenetrate each other as described above, are not aligned perpendicularly at an angle of 90° in relation to the boundary face Z-Z of the core material or core bar. Instead they slope at an angle γ, to meet the boundary face Z-Z obliquely.

FIG. 9 comprises a plan view (as, for example, would be seen in direction of arrow C in FIG. 1) and three sectional illustrations D-D, E-E and F-F of a core material 9.1, which consists of core bars 9.1.1, 9.1.2R and 9.1.2L, 9.1.3R and 9.1.3L. Core bars 9.1.2R and 9.1.2L have the same construction as one another but differ in construction from core bars 9.1.3R and 9.1.3L (which also have the same construction as one another). This combination of differently constructed core bars in one core material enables the properties of the core material to be optimised as needed for the intended application.

Core bar 9.1.1 substantially corresponds to that shown in FIG. 4, wherein the cell volumes, however, are completely filled with a filling material comparable with that shown in FIG. 3. Core bars 9.1.2R and 9.1.2L correspond to that shown in FIG. 8. They are two identical core bars, which, however, are inserted in the core material 9.1 with an opposite direction of slope γ of the lattice cell walls 9.2 between adjacent lattice cells within the same core bar. Core bars 9.1.3R and 9.1.3L are also identical, and are likewise part of the core material 9.1 with opposite directions of slope 6 of the lattice cell walls 9.3. A comparison of core bars 9.1.2R and -L with core bars 9.1.3R and -L shows that in the former it is the lattice cell walls 9.2 between adjacent lattice cells inside the core bar which have a slope in relation to the perpendicular to boundary face Z-Z, but in the latter, as distinct from the former, it is the lattice cell walls 9.3, which inside the core bar are not aligned towards the adjacent lattice cells, which have a slope in relation to the perpendicular to boundary face Z-Z.

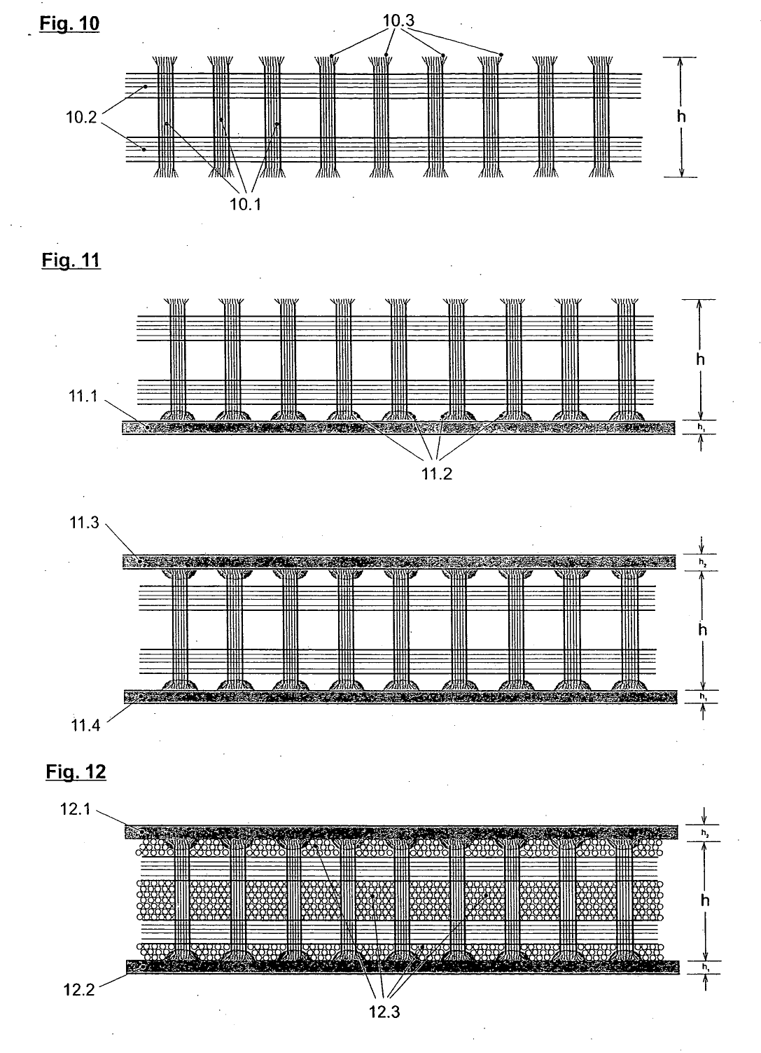

FIG. 10 shows a core material 10.2 with reinforcing fibres 10.1 that have cut ends 10.3 that are splayed, brush-like to provide multiple bristle-like strands at the top and/or bottom surface of the core material.

As seen in FIG. 11, these splayed ends provide wider contact areas 11.2 for the fibres 10.1 to be bonded to a skin/cladding layer on one side (11.1) or both sides (11.3, 11.4) of the core. The skin layers may be glued to the core using an adhesive or applied by spraying or casting methods for example. Where the skin layers are applied by spraying or casting they bond to the brush-like fibres of the reinforcement as they harden.

In FIG. 12, the skin layers 12.1 and 12.2 are bonded to a core material that is the same as that of FIG. 10 but with the lattice cells of the core filled with a filling material 12.3, for example a foamed material as discussed above.

With filled lattice cells, to achieve the desired strength of bond, it is important that the brush-like ends of the reinforcement protrude from the filling material (e.g. foam) sufficiently to allow the brushes to splay. Where the core material is obtained by cutting an elongate member in to slices (as explained in the discussion of FIG. 1 above) it is possible that the brush ends will be embedded in the filling or at least not protrude from it sufficiently. If this is the case, then before the cladding layers are applied, the sliced sections of core material can be treated, for example mechanically or chemically treated, to cause the filling material to shrink sufficiently to reveal the brush-like ends of the reinforcement. Alternatively the treatment may ablate the surface of the filling to reveal the brush ends.

It will be appreciated that the embodiments described above are given by way of example and various modifications to what has been specifically described can be made without departing from the scope of the present invention. For instance, any one or more of the exemplary core bars and cells described above can be combined in any of a number of different ways to form a core material that can then be cladded to provide a light weight building material of sandwich construction.

1. A core material for a multi-layer building material, the core material comprising one or more core bars, each core bar comprising a plurality of lattice cells defined by lattice cell walls, the lattice cell walls comprising a matrix material and a reinforcement material, wherein parts of adjacent lattice cell walls between adjacent lattice cells intersect one another whereby each said lattice cell wall of the pair forms part of the wall defining one of said adjacent cells and at the same time part of the wall defining the other of said adjacent cells.

2. A core material according to claim 1, wherein each of said pair of adjacent lattice cell walls extends uninterrupted in a direction through the intersection of the walls.

3. A core material according to claim 1, wherein said matrix material is selected from the group comprising a bedding material and a sealing material.

4. A core material according to claim 1, wherein said reinforcement material is selected from the group comprising a fibrous reinforcement, a ribbon-shaped reinforcement and a strip-shaped reinforcement.

5. A core material according to claim 1, wherein the walls of the lattice cells comprise permeable mesh apertures.

6. A core material according to claim 1 wherein the volume within one or more of the lattice cells is at least partially filled.

7. A core material according to claim 6 wherein the filling is a foamed material.

8. A core material according to claim 1, wherein the reinforcement material comprises reinforcement elements having brush-like ends.

9. A core material according to claim 8, wherein said brush-like ends are at a surface of the core material for bonding to a cladding layer.

10. A core material according to claim 9, wherein the cladding layer is selected from the group comprising glued skins, sprayed skins and cast skins.

11. A core material according to claim 1 wherein the core height of the material is different in different cross-sectional planes and/or varies within cross-sectional planes.

12. A core material according to claim 1 comprising one or more core bars that are curved along their longitudinal axis.

13. A core material according to claim 1, comprising a plurality of core bars that are curved along their respective longitudinal axes to different degrees.

14. A core material according to claim 1, comprising a plurality of core bars arranged side by side, the material being curved in a direction perpendicular to longitudinal axes of said core bars.

15. A core material according to claim 1, wherein at their upper and lower boundary faces the lattice cells have cross-sectional geometries selected from the group comprising rectilinear, angled and curved lattice cell walls.

16. A core material according to claim 1, wherein the intersecting walls of adjacent lattice cells form the shape of an X.

17. A core material according to claim 1, wherein the intersecting walls of adjacent lattice cells are closed together along a line.

18. A core material according to claim 1, wherein parts of the walls of lattice cells are slanted to meet the upper and lower boundary faces of the core material obliquely.

19. A core material according to claim 1 comprising a plurality of core bars of different construction to one another that are joined together.

20. A core material according to claim 19, comprising core bars with different alignment of the lattice cells in relation to each other.

21. A core material according to claim 19, comprising core bars comprising lattice cells of different cross-sectional geometry.

22. A core material according to claim 19, comprising core bars comprising lattice cells, the cell volumes of which are filled to different extents.

23. A core material according to claim 19, comprising core bars comprising lattice cells, the cell walls of which comprise different materials from one another.

24. A core material according to claim 19, comprising core bars comprising lattice cells, the cell walls of which have different angular positions from one another in relation to the boundary faces of the core material.

25. A building material comprising a core material according to claim 1 sandwiched between two cladding layers.

26. A core material for a multi-layer building material, the core material comprising a plurality of lattice cells defined by lattice cell walls comprising a matrix material and a reinforcement material, wherein said reinforcement material comprises reinforcement elements having brush-like ends at an external surface of the core material.

27. A core material according to claim 26, wherein the volume within one or more of the lattice cells is at least partially filled with a foamed material.

28. A building material comprising a core material according to claim 27 sandwiched between two cladding layers bonded to the brush-like ends of said reinforcement elements.

29. A core material according to claim 27, wherein the foamed material has been treated to reduce its volume to reveal the brush-like ends of the reinforcement elements.
